(19) United States
(12) Patent Application Publication
(10) Pub. No.: US 2005/0140295 A1
(43) Pub. Date: Jun. 30, 2005

(54) High-pressure discharge lamp

(75) Inventor: Hubertus Cornelis Maria Van Den Nieuwenhuizen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKILJKE PHILLLIPS ELECTRONICS N.V.

(21) Appl. No.: 10/510,256

(22) PCT Filed: Mar. 27, 2003
(86) PCT No.: PCT/IB03/01199

(51) Int. Cl. H01K 1/50; H01J 17/00

(52) U.S. Cl. 313/567; 313/607

(57) ABSTRACT

A high-pressure discharge lamp (1) having a quartz glass discharge vessel (2) enclosing a discharge space (3) with an ionizable filling, wherein a first electrode (4) and a second electrode (40) are present between which a discharge is maintained during lamp operation, wherein a first seal (5) incorporates a first internal electrical conductor (6) which 5 connects the first electrode (4) to a first external electrical conductor (7) extending from the seal (5) to the exterior, wherein said first seal (5) further incorporates a gas-filled cavity (10) which is at least partially surrounded by an external capacitive body (42, 42′, 43, 44, 45, 45′, 46, 48), and wherein said external capacitive body (42, 42′, 43, 44, 45, 45′, 46, 48) is electrically isolated from the first and second electrodes (4, 40).

The invention relates to a high-pressure discharge lamp having a quartz glass discharge vessel enclosing a discharge space with an ionizable filling, wherein a first electrode and a second electrode are present between which a discharge is maintained during lamp operation, wherein a first seal incorporates a first internal electrical conductor which connects the first electrode to a first external electrical conductor extending from the seal to the exterior, wherein said first seal further incorporates a gas-filled cavity which is at least partially surrounded by an external capacitive body. A lamp of the type described is known from WO 00/77826. The known lamp is suitable for operation in air, i.e. without an outer envelope. For lamps intended for an accurate formation of a beam by means of an optical system, this is an important advantageous aspect. Particularly for applications such as, for example, in projectors, and motor vehicle headlamps, the avoidance of optical disturbances caused by an outer envelope plays an important role. It is important that the temperature of the electrical conductor has a relatively low value at the area where it is exposed to air, in order that a rapid oxidation of the conductor is prevented. In the known lamp, this is realized by elongating the seal. In this description and the claims, quartz glass is understood to mean a glass having an SiO₂ content of at least 95%.

In high-pressure discharge lamps, an ignition delay often occurs in practice when igniting the lamp. The risk of an ignition delay strongly increases when the lamp has been in the dark for some time. The occurrence of an ignition delay is a great drawback and, under circumstances, may lead to dangerous situations, for example when a high-pressure lamp is used as a motor vehicle headlamp.

The known lamp has the advantage that the available cavity and the metal capacitive body, which is connected to the second electrode by means of a separate conductor, constitute a start-promoting means in the form of a source of UV radiation when a electric voltage is applied across the cavity. The UV radiation source is referred to as UV enhancer.

One drawback of the known lamp is that the conductor which connects the capacitive body near the first seal to the second electrode near the second seal reduces the light emitted from the discharge vessel and reflected by a reflector which in the lamp is mounted. This can also cause unwanted shades. Furthermore, the conductor is visible from the outside as a disturbing loose wire.

Another drawback of said lamp is that it is difficult to manufacture such a lamp, in which the conductor wire must be welded to the electrode, while the lamp with the conductor wire, which extends outside the lamp, must be mounted carefully in the reflector in order not to interfere with other components.

It is an object of the invention to provide a accurate and reliable lamp which is easy and efficient to produce, wherein the aforementioned drawbacks are alleviated.

According to the invention, a high-pressure discharge lamp of the type described in the opening paragraph is characterized in that said external capacitive body is electrically isolated from the first and second electrodes. It was surprisingly discovered that the capacitive body and the gas-filled cavity of the lamp, which is used in a resonance ignition system at a frequency of, for example, 150 kHz, still function as start-promoting means, even if the capacitive body is electrically isolated, i.e. not connected to an electrode. Therefore, the electrodes of said lamp are preferably connected to a resonance ignition system having an ignition frequency of at least 50 kHz, preferably approximately 150 kHz. The advantage of an isolated capacitive body is that said conductor is not necessary anymore, resulting in a better lighting performance and easier lamp manufacture.

In a first preferred embodiment, the external capacitive body comprises a wire which is wound around the seal. In a second preferred embodiment, the external capacitive body comprises a resilient body which clamps itself partially around the seal. Other embodiments are of course possible and will be obvious to those skilled in the art.

In an advantageous embodiment of the lamp according to the invention, the internal electrical conductor is a foil which extends through the cavity. On the one hand, this is a considerable simplification of the seal construction and its manufacture and, on the other hand, it has the important advantage that a strong concentration of an electric field is produced at the edges of the foil as soon as a voltage is applied to the conductor. This enhances breakdown in the UV enhancer.

Preferably, the gaseous constituent of the filling in the cavity comprises mercury vapor and preferably furthermore a rare gas such as argon. This has the advantage that relatively much UV radiation is generated by the UV enhancer, which particularly contributes to a rapid and reliable cold ignition, or a rapid ignition in the dark. A further advantage of the lamp according to the invention is that no separate mercury dosage appears to be necessary. This is easily realizable by making the first seal after the discharge vessel has been provided with its filling. For the purpose of electrical connection of the second electrode, the lamp is provided with a second seal for feedthrough of an electrical conductor to the second electrode. For reasons of an efficient manufacture of the lamp according to the invention, this second seal has the same construction as the first seal.

The invention also relates to a lamp assembly, wherein the lamp according to the invention is mounted in a holder of a lamp reflector, wherein said capacitive body is at least partially mounted within said holder. Preferably said lamp and said capacitive body are mounted together in said holder by means of cement. The capacitive body then does not obstruct the light that is emitted from the lamp.

The invention furthermore relates to a method of manufacturing a high-pressure discharge lamp wherein a quartz glass discharge vessel enclosing a discharge space is filled with an ionizable filling, wherein a first electrode and a second electrode are placed such that a discharge can be maintained during lamp operation, wherein a first seal is provided with a first internal electrical conductor which connects the first electrode to a first external electrical conductor extending from the seal into the exterior, wherein said first seal is further provided with a gas-filled cavity which is at least partially surrounded by an external capacitive body, an wherein said external capacitive body is electrically isolated from the first and second electrodes.

These and other aspects of the invention are apparent from and will be elucidated with reference to the embodiments described hereinafter. In the drawings:

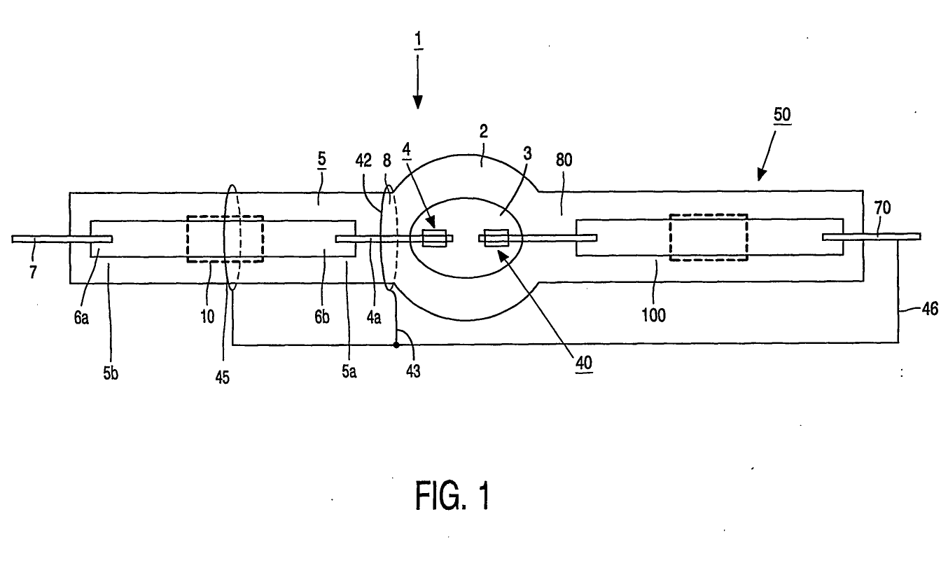

FIG. 1 shows a prior art lamp, comprising a collapsed seal;

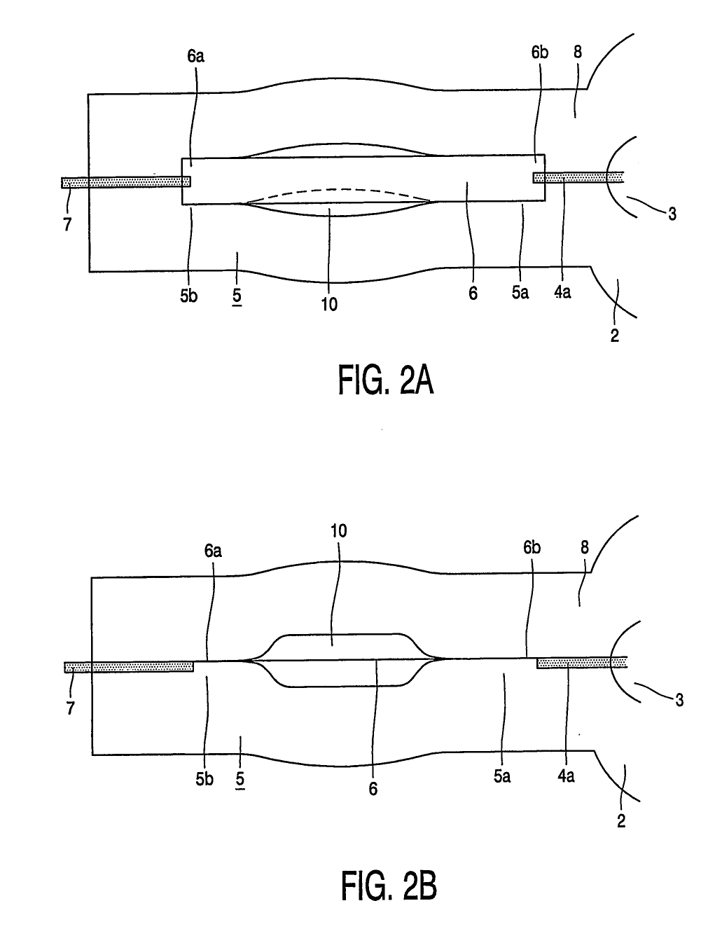

FIG. 2 shows the collapsed seal of FIG. 1 in detail;

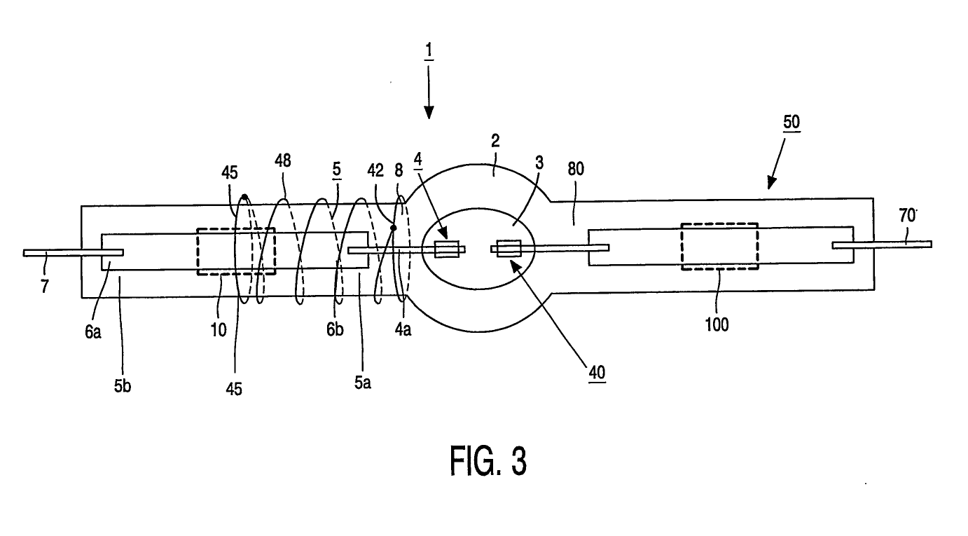

FIG. 3 shows an embodiment of the lamp according to the invention;

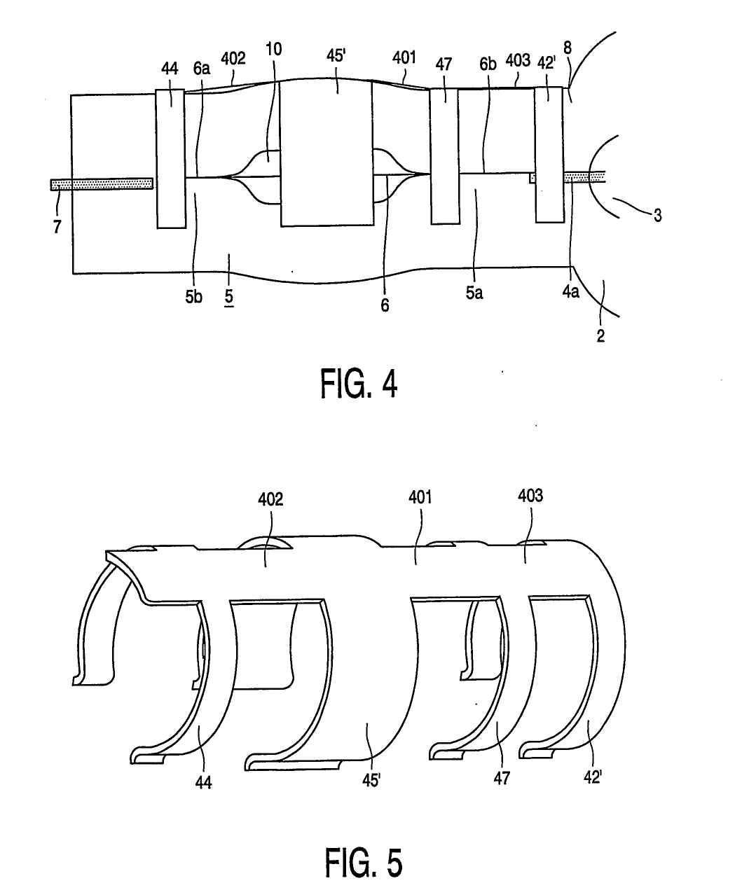

FIG. 4 shows a seal provided with a resilient clamp body; and

FIG. 5 is a side elevation of the resilient clamp body.

FIG. 1 (not true to scale) shows a high-pressure discharge lamp 1 provided with a glass discharge vessel 2 which encloses a discharge space 3 with an ionizable filling, in which a first electrode 4 and a second electrode 40 are present between which a discharge extends during lamp operation, and having a first seal 5 incorporating an electrical conductor 6 in the form of a foil which connects the first electrode 4 to a metal wire 7 projecting to the exterior from the first seal, which first seal has a first gastight portion 5a and a second gastight portion 5b between which a gas-filled cavity 10 is present. The cavity comprises at least a gaseous constituent of the filling. For example, the cavity comprises mercury vapor and argon.

At the area of the cavity, the first seal has a first external capacitive body 45. The first seal is connected to the discharge vessel at the area of a neck 8. At the area of the neck, a second external capacitive body 42 is present which is electrically connected to the first external capacitive body by means of a conductor 43. The capacitive body 42 increases the electric field inside the vessel around the electrode 4. The first seal 5 constitutes a collapsed seal. The foil 6 is an Mo strip having knife edges. The metal wire 7 is secured to one end 6a of the strip, for example by welding, and projects to the exterior from the seal and from the discharge vessel. An electrode rod 4a of the first electrode 4 is secured to a further end 6b of the strip 6. On the side facing the first electrode 4, the discharge vessel has a second electrode 40 and a second seal 50, with a cavity 100 and a neck 80, of a comparable construction. The second electrode is connected to a wire 70. In the operating condition of the lamp, a discharge extends between the electrodes. In the embodiment described, the first and the second external capacitive body 45, 42 are electrically connected to the second electrode 40 by means of a conductor 46. Thus a passive serial capacitive body is realized. FIG. 2 (not true to scale) shows the first collapsed seal of the lamp of FIG. 1 in detail, in which FIG. 2A shows the first seal with strip 6 in a plan view and FIG. 2B shows it with strip 6 in a side elevation. In FIG. 2, the capacitive bodies 45 and 43 are not shown for the sake of clarity. In a first embodiment of the lamp according to the invention shown in FIG. 3, the first capacitive body 45 is an electrically isolated first wire loop of an electrically isolated wire 48 at the area of the cavity 10, which is wound with some turns around the first seal 5 as far as the neck 8 where it forms the capacitive body 42. This embodiment is advantageous because of the possibility of a simple construction of the capacitive bodies 45 and 42, formed from a single wire. Since the lamp operates at a very high frequency of, for example 150 kHz between the electrodes, a connection between the capacitive bodies 45 and 42 and the electrode 40 is not necessary for applying the necessary voltage across the cavity 10, since this voltage is already generated in the capacitive bodies by capacitance coupling.

In an advantageous embodiment of the lamp, the capacitive bodies are formed as resilient clamp bodies. FIG. 4 shows (not true to scale) how the first seal is provided with such capacitive bodies. In the embodiment shown, the first seal, which has a substantially round circumference, is clamped by four resilient clamp bodies. A first resilient clamp body 45′ located at the cavity forms the first capacitive body, and a second resilient clamp body 42′ located at the neck 8 forms the second capacitive body. A third resilient clamp body 44 is located close to the second gastight portion 5a of the first seal. A fourth resilient clamp body 47 is provided in between the resilient clamp bodies 45′ and 42′. The resilient clamp bodies 44, 42′, 45′, 47 are interconnected by connection bodies 401, 402, 403. Due to the presence of the cavity 10, the circumference of the first seal is somewhat larger at the cavity than on either side thereof. Preferably, the fourth resilient clamp body is located immediately beside the larger circumference. The configuration shown has the advantage that the position of the first capacitive body 45′ is substantially fixed in this way due to the differences in the circumference. A further advantage is that the capacitive bodies can be produced as separate lamp parts and can be mounted on the lamp in a simple way afterwards. Preferably, the resilient clamp bodies and the connection bodies are made in one piece. FIG. 5 is a side elevation of the resilient clamp bodies 44, 45′, 42′, 47 and connection bodies 401, 402, 403 made in one piece.

In a practical realization of the lamp in accordance with the embodiment shown, the lamp is a high-pressure mercury discharge lamp having a nominal power of 120 W. The lamp, which is intended for projection purposes, has a discharge vessel with an internal diameter of 4 mm and an electrode distance of 1 mm. The discharge vessel has an ionizable filling which, in addition to mercury and a rare gas, for example argon having a filling pressure of 100 mbar, also comprises bromine. During operation of the lamp, a pressure of 160 bar or more prevails in the discharge vessel. The discharge vessel is made of quartz glass having a greatest thickness of 2.5 mm. The knife-edged strip is an Mo strip to which a metal wire is secured at one end. An electrode rod of a first electrode is secured to the other end of the strip. The lamp is provided on each side with a collapsed seal, each seal having a length of 28 mm. A length of 5 mm of the collapsed seal is already adequate for hermetically sealing the discharge vessel. The remaining length of the collapsed seal is used to give the temperature of the electrical conductor a sufficiently low value at the area where it is exposed to air. Each collapsed seal has a cavity. Each collapsed seal has a length of 7 mm between the discharge space and the relevant cavity. Each cavity has a length of 5 mm or even less.

The first seal is provided with a first capacitive body at the area of the cavity, in the form of a wire winding which extends in 2 to 3 turns as far the neck between the seal and the discharge vessel, where it forms a second capacitive body in a closed winding. The second capacitive body is spaced apart from the discharge space by a distance of between 1 mm and 3 mm. The wire has a diameter of 0.5 mm.

In a further practical realization, the first seal is provided with four resilient clamp bodies made of an electrically conductive, heat-resistant material, in the case described stainless steel RVS310. The resilient clamp body located at the cavity has a width of 3 mm. The other resilient clamp bodies each have a width of 1 mm. The resilient clamp bodies are interconnected by connection bodies having a width of 2 mm. The resilient clamp bodies and the connection bodies are made from one piece of material.

The lamp manufacture starts from a quartz glass tube in which a vessel is formed which is provided with tubular parts at two diametrically opposed locations, which tubular parts will serve for the manufacture of seals. First, a seal is made on the lamp vessel, for example a collapsed seal after a knife-edged strip and a conductor and electrode secured thereto in known manner have been provided, which collapsed seal is realized by heating the relevant tubular part in such a way that it softens and flows out under the influence of a prevailing sub-atmospheric pressure. This is preferably done by means of a laser beam rotating with respect to the tubular part, which rotating beam is moved from the conductor towards the electrode rod. By interrupting the laser beam at the location of the strip for some time, a gastight cavity is realized. The cavity thus formed contains a gas which is present in the tubular part and the discharge space during manufacture of the collapsed seal. This is generally a rare gas with which the quartz glass tube is flushed during manufacture of the seal. For reasons of efficient manufacture, the rare gas which will form part of the filling of the discharge vessel will preferably be used for this purpose. Subsequently, the discharge vessel is provided with the constituents required for the filling, whereafter a knife-edged strip with secured electrode and ditto conductor is provided at the area of the other tubular part. Subsequently, a collapsed seal is made in a corresponding manner also in the other tubular part by heating and consequent flowing of the tubular part. The cavity thus formed is thus also automatically filled with vapor of the filling present in the discharge vessel, particularly mercury vapour. This is a great advantage for a satisfactory start-enhancing operation. It has been found that the collapsed seals thus formed qualitatively constitute equally good seals as in the case where the collapsed seals do not have a gastight cavity. A practical lamp of the type described above requires a resonant voltage of 1.5 kV for cold ignition, for example a voltage in the form of a high-frequency signal during 1 to 3 ms of, for example, 50 kHz for generating a breakdown in the cavity, where upon substantially instantaneously a discharge is produced in the discharge vessel between the electrodes, which will subsequently develop into a stable discharge arc so that the lamp operates in a stable manner. The lamp reaches its stable operating state after no more than 1 minute. In the same practical lamp, a maximum strike delay occurs after extinction of the lamp upon hot restrike of the lamp by means of a high-frequency signal of 5 kV after at most 60 s, with the power supplied during hot restrike to the lamp remaining limited to 120 W. In the case of a comparable lamp without a cavity in one of the seals, the required ignition voltage is 20 kV under otherwise equal conditions.

1. A high-pressure discharge lamp having a quartz glass discharge vessel enclosing a discharge space with an ionizable filling, wherein a first electrode and a second electrode are present between which a discharge is maintained during lamp operation, wherein a first seal incorporates a first internal electrical conductor which connects the first electrode to a first external electrical conductor extending from the seal to the exterior, wherein said first seal further incorporates a gas-filled cavity which is at least partially surrounded by an external capacitive body, characterized in that said external capacitive body is electrically isolated from the first and second electrodes.

2. A lamp as claimed in claim 1, wherein the external capacitive body comprises a wire which is wound around the seal.

3. A lamp as claimed in claim 1, wherein the external capacitive body comprises a resilient body which clamps itself partially around the seal.

4. A lamp as claimed in claim 1, wherein the internal electrical conductor is a foil which extends through the cavity.

5. A lamp as claimed in claim 1, wherein the gas filling of the cavity comprises mercury vapor.

6. A lamp assembly, wherein the lamp as claimed in claim 1 is mounted in a holder of a lamp reflector, and wherein said capacitive body is at least partially mounted within said holder.

7. A lamp assembly as claimed in claim 6, wherein said lamp and said capacitive body are mounted in said holder by means of cement.

8. A lamp assembly as claimed in claim 6, wherein the electrodes of said lamp are connected to a resonance ignition system having a frequency of at least 50 kHz, preferably approximately 150 kHz.

9. A method of manufacturing a high-pressure discharge lamp, whereby a quartz glass discharge vessel enclosing a discharge space is filled with an ionizable filling, whereby a first electrode and a second electrode are placed such that a discharge can be maintained during lamp operation, whereby a first seal is provided with a first internal electrical conductor which connects the first electrode to a first external electrical conductor extending from the seal to the exterior, and whereby said first seal is further provided with a gas-filled cavity which is at least partially surrounded by an external capacitive body, characterized in that said external capacitive body is electrically isolated from the first and second electrodes.
